(19) United States
(12) Patent Application Publication
(10) Pub. No.: US 2011/0119216 A1
(43) Pub. Date: May 19, 2011

(54) NATURAL INPUT TRAINER FOR GESTURAL INSTRUCTION

(75) Inventor: Daniel J. Wigdor, Seattle, WA (US)

(73) Assignee: MICROSOFT CORPORATION, Redmond, WA (US)

(21) Appl. No.: 12/619,575

(22) Filed: Nov. 16, 2009

(51) Int. Cl. G06F 3/033; G06F 3/01; G06N 5/02

(52) U.S. Cl. 706/46; 715/863; 715/709

(57) ABSTRACT

A computing device that detects precursory user-input preactions executed in an instructive region and user-input action gestures executed in a functionally-active region is provided. The computing device includes a natural input trainer to present a predictive input cue on a display in response to detecting a precursory user-input preaction performed in the instructive region. The computing device also includes an interface engine to execute a computing function in response to detecting a successive user-input action gesture performed in the functionally-active region subsequent to detection of the precursory user-input preaction.

### BACKGROUND

Computing devices may be configured to accept input from different types of input devices. For example, some computing devices utilize a pointer based approach in which graphics, such as buttons, scroll bars, etc., may be manipulated via a mouse, touch-pad, or other such input device, to trigger computing functions. More recent advances in natural user interfaces have permitted the development of computing devices that detect touch inputs.

However, in some use environments, the number of touch inputs may be significant and require a user to commit a large amount of time to learning the extensive set of touch inputs. Therefore, infrequent or novice users may experience frustration and difficulty when attempting to operate a computing device utilizing touch inputs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing device that detects precursory user-input preactions executed in an instructive region and user-input action gestures executed in a functionally-active region is provided. The computing device includes a natural input trainer to present a predictive input cue on a display in response to detecting a precursory user-input preaction performed in the instructive region. The computing device also includes an interface engine to execute a computing function in response to detecting a successive user-input action gesture performed in the functionally-active region subsequent to detection of the precursory user-input preaction.

### BRIEF DESCRIPTION OF THE DRAWINGS

FIG. 1 schematically shows an example embodiment of a computing device including an input-sensing subsystem configured to detect precursory user-input preactions executed in an instructive region and user-input action gestures executed in a functionally-active region.

FIG. 2 illustrates an example input sequence in which a precursory user-input preaction is performed in an instructive region proximate to a display and a user-input action gesture is subsequently performed against a display.

FIG. 3 illustrates another example input sequence in which a precursory user-input preaction is performed in an instructive region proximate to a display and a user-input action gesture is subsequently performed against a display.

FIG. 4 illustrates an example input sequence in which a precursory user-input preaction, which is not in a recognizable posture, is performed proximate to a display.

FIG. 5 illustrates an example input sequence in which a precursory user-input preaction having a form that is not preferred is performed.

FIG. 6 illustrates another example input sequence in which a first and a second predictive input cue is presented on a display responsive to a precursory user-input preaction performed in an instructive region.

FIG. 7 illustrates another example embodiment of a computing device including an input-sensing subsystem configured to detect precursory user-input preactions executed in an instructive region and user-input action gestures executed in a functionally-active region.

FIG. 8 shows another exemplary embodiment of a computing device including an input device spaced away from the display and configured to detect precursory user-input preactions executed in an instructive region and user-input action gestures executed in a functionally active region.

FIG. 9 shows a process flow depicting an example method for operating a computing device.

FIG. 10 shows another process flow depicting an example method for operating a computing device.

### DETAILED DESCRIPTION

The present disclosure is directed to a computing device that a user can control with natural inputs, including touch inputs, postural inputs, and gestural inputs. Predictive input cues are presented on a display of the computing device to provide the user with instructive input training, allowing a user to quickly learn gestural inputs as the user works with the device. A separate training mode is not needed. The predictive input cues may include various graphical representations of proposed user-input gestures having associated computing functions. Additionally, the predictive input cues may include a contextual function preview graphically representing a foreshadowed implementation of the computing function. In this way, instructions pertaining to the implementation of a predicted user-input gesture as well as a preview of the computing function associated with the predicted user-input gesture may be provided to the user.

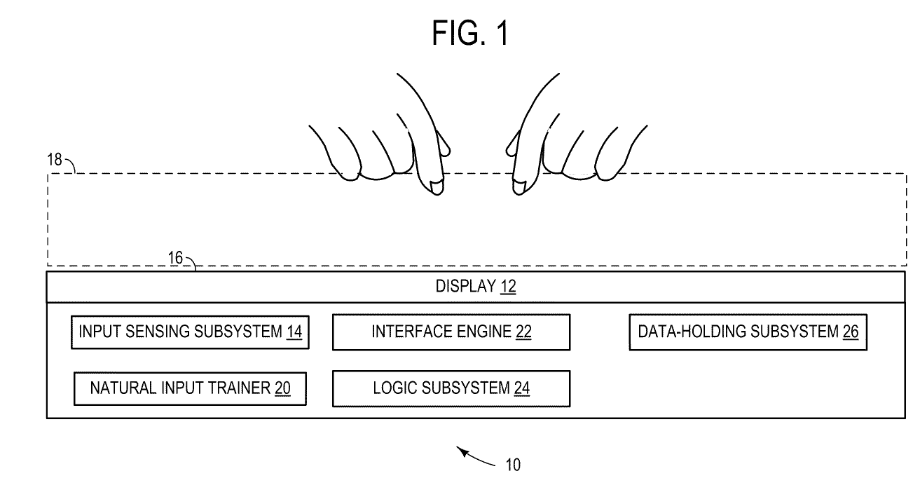

FIG. 1 shows a schematic depiction of a computing device 10 including a display 12 configured to visually present images to a user. The display 12 may be any suitable touch display, nonlimiting examples of which include touch-sensitive liquid crystal displays, touch-sensitive organic light emitting diode (OLED) displays, and rear projection displays with infrared, vision-based, touch detection cameras.

The computing device 10 includes an input sensing subsystem 14. Suitable input sensing subsystems may include an optical sensing subsystem, a capacitive sensing subsystem, a resistive sensing subsystem, or a combination thereof. It will be appreciated that the aforementioned input sensing subsystems are exemplary in nature and alternative or additional input sensing subsystems may be utilized in some embodiments.

The input sensing subsystem 14 may be configured to detect user-input of various types. As explained in detail below, user input can be conceptually divided into two types—precursory preactions and action gestures. Precursory preactions refer to, for example, the posture of a user's hand immediately before initiating an action gesture. A precursory preaction effectively serves as an indication of what action gesture is likely to come next. An action gesture, on the other hand, refers to the completed touch input that a user carries out to control the computing device.

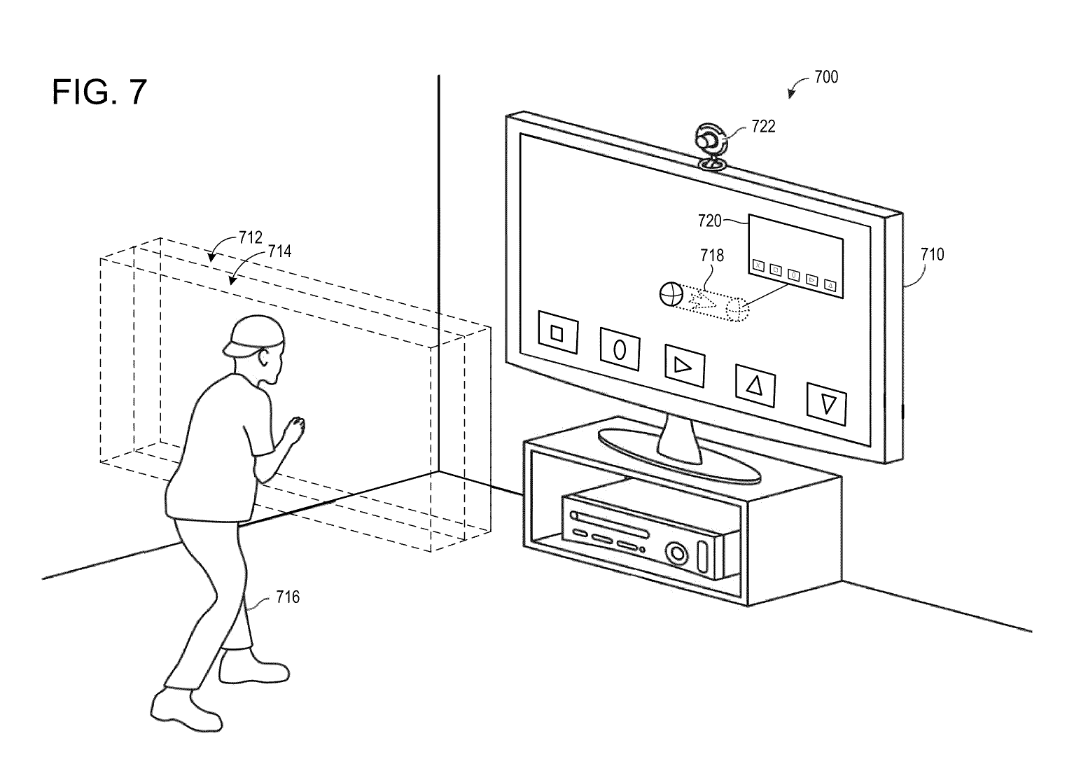

The input sensing subsystem 14 may be configured to detect both precursory user-input preactions executed in an instructive region and user-input action gestures executed in a functionally-active region. In the embodiment depicted in FIG. 1, the precursory user-input preactions are user-input hovers staged away from the display and the user-input action gestures are user-input touches executed against the display. Therefore, the functionally-active region is a sensing surface 16 of the display and the instructive region is a region 18 directly above a sensing surface of display. It will be appreciated that the functionally-active region and the instructive region may have different spatial boundaries and the precursory user-input preaction and the user-input action gestures may be alternate types of inputs. An example alternative embodiment is discussed below with reference to FIG. 7. As another alternative, a touch pad that is separate from the display may be used to detect user-input touches executed against the touch pad and user-input hovers staged away from the display above the touch pad. It will be appreciated that the geometry, size, and location of the instructive region and the functionally-active region may be selected based on the constraints of the input sensing subsystem as well as the bio-mechanical needs of the user.

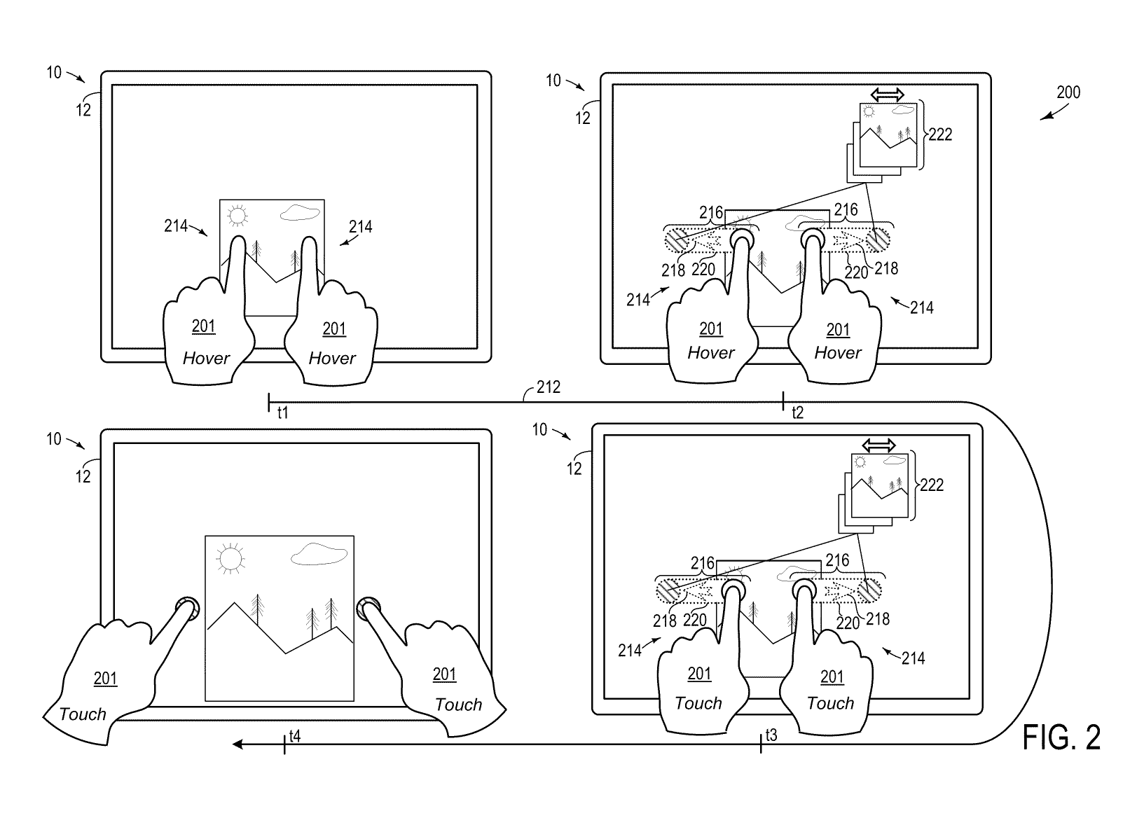

The computing device 10, depicted in FIG. 1, may further include a natural input trainer 20 configured to present a predictive input cue on the display 12 in response to the input sensing subsystem 14 detecting a precursory user-input preaction staged away from the display 12. In this way, the natural input trainer 20 may provide graphical indications of a proposed user-input gesture, as described below by way of example with reference to FIGS. 2-6.

The computing device 10 may additionally include an interface engine 22 to execute a computing function in response to the input sensing subsystem 14 detecting a successive action gesture performed in the functionally-active region subsequent to detection of the precursory posture. The natural input trainer 20 and the interface engine 22 are discussed in greater detail herein with reference to FIGS. 2-8.

FIGS. 2-6 illustrated various user-inputs and computing functions executed on display 12 of computing device 10. The text “hover” and “touch” marked on the hands 201 shown in FIGS. 2-6 is provided to differentiate between a user-input hover and a user-input touch. Therefore, the hands marked “hover” indicate that the hand is position in an instructive region above the display and the hands marked “touch” indicate that a portion of the hand is in direct contact with a sensing surface of the display.

FIG. 2 shows an input sequence 200 in which a user-input hover is staged away from the display 12 of the computing device 10 and a user-input touch is implemented against the display. Various steps in the user-input sequence are delineated via a timeline 212, which chronologically progresses from time t1 to time t4.

At t1, an input sequence is initiated by a user. The initiation is executed through implementation of a precursory posture 214. In the depicted scenario, the precursory posture 214 is a hover input performed by the user staged away from the display in an instructive region (i.e., the space immediately above the display 12). However, it will be appreciated that the precursory posture may be another type of input. As previously discussed, a user-input hover may include an input in which one or more hands are positioned in an instructive region adjacent to the display. In some examples, the relative position of the fingers, palm, etc., may remain substantially stationary, and in other examples the posture can dynamically change.

An input sensing subsystem (e.g., input sensing subsystem 14 of FIG. 1) may detect the precursory posture (e.g., user-input hover). In this particular embodiment, a natural input trainer (e.g., natural input trainer 20 of FIG. 1) may determine the characteristics of the detected user-input hover. The characteristics may include a silhouette shape of the hover input, the type and location of digits in the hover input, angles and/or distances between selected hover input points, etc. It will be appreciated that additional or alternate characteristics may be considered. The characteristics of the user-input hover may be compared to a set of recognized postures. Each recognized posture may have predetermined tolerances, ranges, etc. Thus if the characteristics of the user-input hover fall within the predetermined tolerances and/or ranges a correspondence is drawn between the user-input hover and a recognized posture. Other techniques may additionally or alternatively be used to determine if a user-input hover corresponds to a recognized posture.

If a correspondence is drawn between the user-input hover and the recognized posture, a predictive input cue may be presented on the display by a natural input trainer (e.g., natural input trainer 20 of FIG. 1), as shown at t2 of FIG. 2. The predictive input cue may include a graphical representation 216 of a proposed user-input action gesture that is executable in the functionally-active region (e.g., on the display surface). It will be appreciated that the precursory user-input preaction (e.g., user-input hover) may be an introductory step in the user-input action gesture. In this particular scenario the proposed user-input action gesture is a user-input touch executable against the display and associated with a computing function. However, alternate types of proposed user-input gestures may be graphically depicted. In this way, the natural input trainer may present a predictive input cue on the display in response to the input sensing subsystem detecting the precursory input gesture. The input cue can be presented on the display before a user continues to perform an action gesture. Therefore, the input cue can serve as visual feedback that provides the user with real time training and can help the user perform a desired action gesture. It will be appreciated that alternate actions may be used to trigger the presentation of the predictive input cue in some embodiments.

The graphical representation 216 of the proposed user-input action gesture may include various icons such as arrows 218 illustrating the general direction of the proposed input as well as a path 220 depicting the proposed course of the input. Such graphical representations provide the user with a graphical tutorial of a user-input action gesture. In some examples, the graphical representation may be at least partially transparent so as not to fully obstruct other objects presented on the display. It will be appreciated that the aforementioned graphical representation of the proposed user-input action gesture is exemplary in nature and that additional or alternate graphical elements may be included in the graphical representation. For example, alternate or additional icons may be provided, shading and/or coloring techniques may be used to enhance the graphical depiction, etc. Furthermore, audio content may be used to supplement the graphical representation.

The graphical representation 216 of the proposed user-input action gesture may be associated with a computing function. In other words, execution of the proposed user-input action gesture by a user may trigger a computing function. In this example, the computing function is a resize function. In other examples, alternate computing functions may be used. Exemplary computing functions may include, but are not limited to, rotating, dragging and dropping, opening, expanding, graphical adjustments such as color augmentation, etc.

Continuing with FIG. 2, the predictive input cue may further include a contextual function preview 222 graphically representing a foreshadowed implementation of the computing function. Thus, a user may see a preview of the computing function, allowing the user to draw a cognitive connection between the user-input action gesture and the associated computing function before an action gesture is implemented. In this way, a user can quickly learn the computing functions associated with various input gestures without having to carry out the actual gestures and corresponding computing functions. A user may also quickly learn if a particular gesture will not produce an intended result, thus allowing a user to abandon a gesture before bringing about an unintended result.

A user may choose to implement the proposed user-input action gesture in the functionally-active region, as depicted at t3 and t4 of FIG. 2. The input sensing subsystem may detect the user-input action gesture. The interface engine may receive the detected input and in response execute the computing function (e.g., resize) associated with the user-input action gesture. In the illustrated embodiment, the functionally-active region is the surface of the display. However, it will be appreciated that in other embodiments the functionally-active region may be bounded by other spatial constraints, as discussed by way of example with reference to FIG. 7.

In some embodiments, a natural input trainer may further be configured to present the predictive input cue after the user-input hover remains substantially stationary for a predetermined period of time. In this way, a user may quickly implement a user-input action gesture (e.g., user-input touch) without assistance and avoid an extraneous presentation of the predictive input cue when such a cue is not needed. Likewise, a user may implement a user-input hover by pausing for a predetermined amount of time to initiate the presentation of the predictive input cue. Alternatively, the predictive input cue may be presented directly after the user-input hover is detected.

A user-input hover that remains stationary for an extended amount of time after a first predictive input cue is presented may indicate that a, user needs further assistance. Therefore, the natural input trainer may be configured to present a second predictive input cue after the user-input hover remains substantially stationary for a predetermined period of time. The second cue can be presented in place of the first cue or in addition to the first cue. The second cue, and subsequent cues, can be presented to the user in an attempt to offer the user a desired gesture and resulting computing function when the natural input trainer determines the user is not satisfied with the options that have been offered.

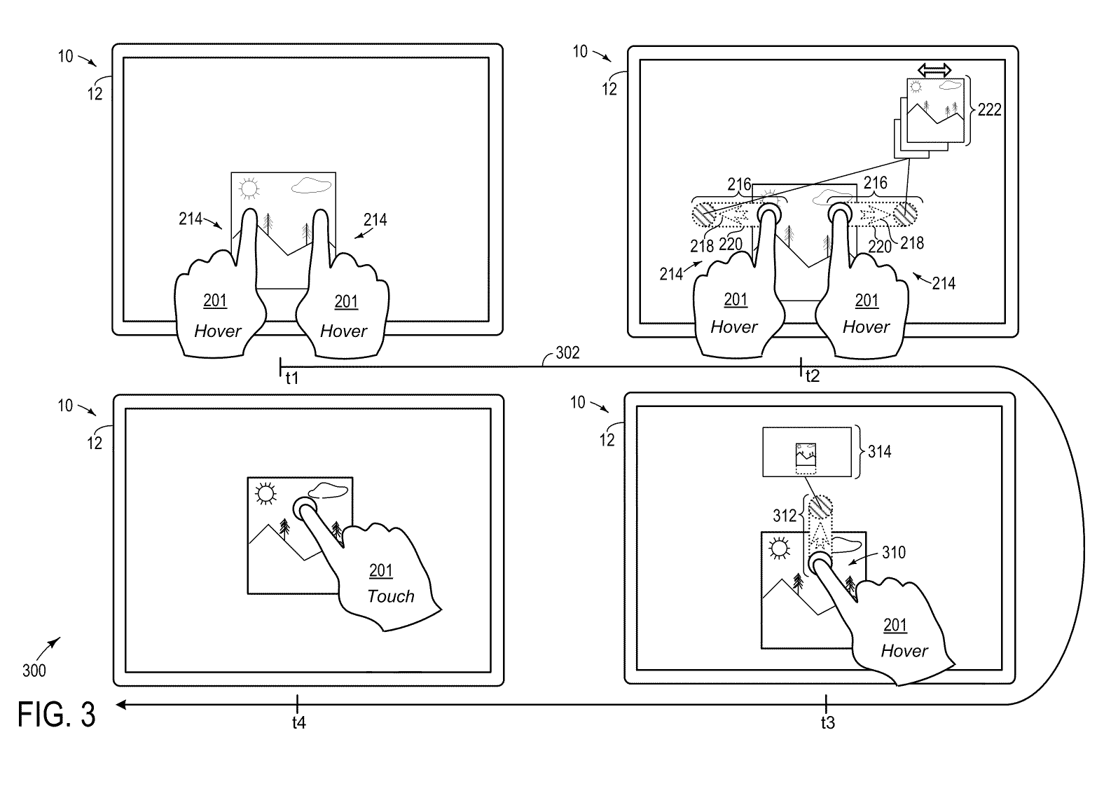

FIG. 3 shows an input sequence 300 in which a first user-input hover is staged away from the display 12 of the computing device 10, and then a second user-input hover is staged before a user-input touch is implemented against the display. Various steps of the user-input sequence are delineated via a timeline 302.

Times t1 and t2 of FIG. 3 correspond to times t1 and t2 of FIG. 2. That is, timeline 302 of FIG. 3 begins the same as timeline 212 of FIG. 2. However, unlike timeline 212 where the user executes a user-input action gesture after the first predictive input cue is presented, timeline 302 shows the user instead staging a second user-input hover 310 above display 12. For example, a user may observe the predictive input cue and realize that the user-input action gesture (e.g., user-input touches) associated with the user-input hover is not what the user intends to implement. In such cases, the user may perform a second user-input hover in an attempt to learn the user-input action gesture that will bring about the intended result. In this way, a user may try out a number of different input hovers if the user is unfamiliar with the user-input action gestures and associated computing functions.

If a the natural input trainer determines that the second user-input hover 310 corresponds to a recognized posture, the natural input trainer may present a second predictive input cue on the display in response to the input sensing subsystem detecting the second user-input hover. The second gestural cue may include a graphical representation 312 of a second proposed user-input action gesture executable in the functionally-active region (e.g., against the display) and associated with a second computing function. As shown, the second predictive input cue is different from the first predictive input cue. The predictive input cue may further include a contextual function preview 314 graphically representing a foreshadowed implementation of the second computing function. A user may then choose to execute the second proposed user-input action gesture against the display. In response to the execution and subsequent detection of the gesture by the input sensing subsystem, the interface engine may implement a computing function (e.g., drag), as shown at t4.

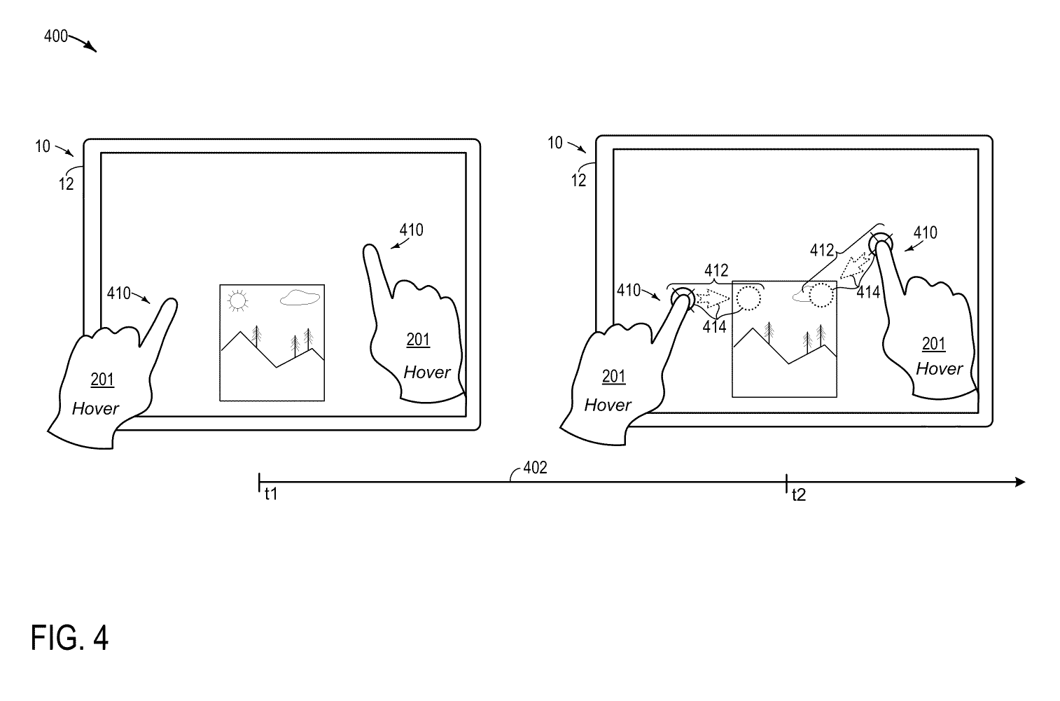

FIG. 4 shows an input sequence 400 in which a user-input hover is staged away from the display 12. Various steps of the user-input sequence are delineated via a timeline 402. At t1, an input sequence is initiated by a user. The initiation is executed through implementation of a user-input hover 410. In the depicted scenario, the user-input hover is detected by an input sensing subsystem and it is determined by a natural input trainer that the user-input hover 410 does not correspond to a recognized posture.

At t2, a predictive input cue including a graphical representation 412 of a proposed precursory user-input preaction is presented on the display. The proposed input precursory posture may include various graphical elements 414 indicating the configuration and location of a recognized user-input posture so that a user may adjust the unrecognized hover into a recognized posture. The proposed input precursory posture may be selected based on the characteristics of the user-input hover 410. In this way, a user may be instructed to perform a recognized user-input hover subsequent to detection of an unrecognizable user-input hover. Additionally, the proposed user-input hover may be associated with at least one input gesture and corresponding computing function.

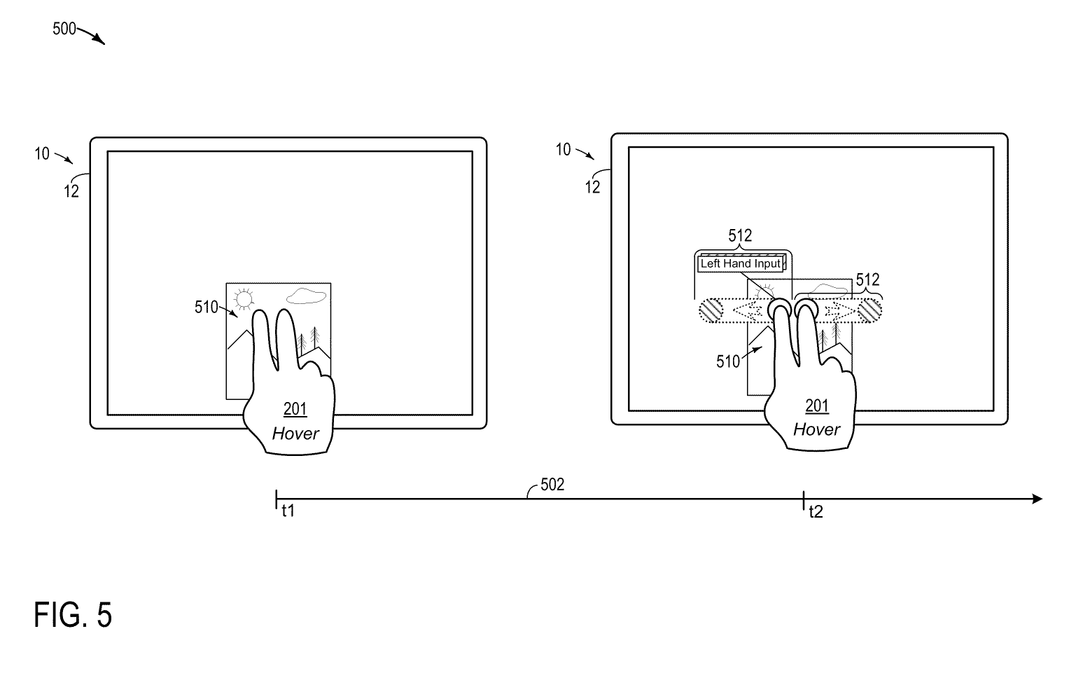

FIG. 5 shows an input sequence in which a user-input hover 510 is staged away from the display 12. Various steps of the user-input sequence are delineated via a timeline 502. At t1, an input sequence is initiated by a user. The initiation is executed through implementation of a user-input hover 510. In the depicted scenario, the user-input hover is detected by an input sensing subsystem, as described above. The user-input is determined to have a recognized posture and an unconventional form or a form that is not preferred by a natural input trainer.

The form of the user-input hover may be assessed based on various characteristics of the user-input hover, such as the input hand (i.e., right hand, left hand), the digits used for input, the location of the input(s), etc. In some examples a conventional form may be bio-mechanically effective. That is to say that the user may complete an input gesture initiated with an input posture without undue strain or stress on their body (e.g., fingers, hands, and arms). For example, the distance a user can spread two digits on a single hand is limited due to the configuration of the joints in their fingers. Thus, a spreading input performed with two digits on a single hand may not be a bio-mechanically effective form. However, a spreading input performed via bi-manual input may be a bio-mechanically effective form. Thus, a predictive input cue including a graphically representation 512 of a proposed user-input hover suggesting a bi-manual input may be presented on the display. In the depicted embodiment, the predictive input cue includes text. However, in other examples additional or alternate graphical elements or auditory elements may be used to train the user.

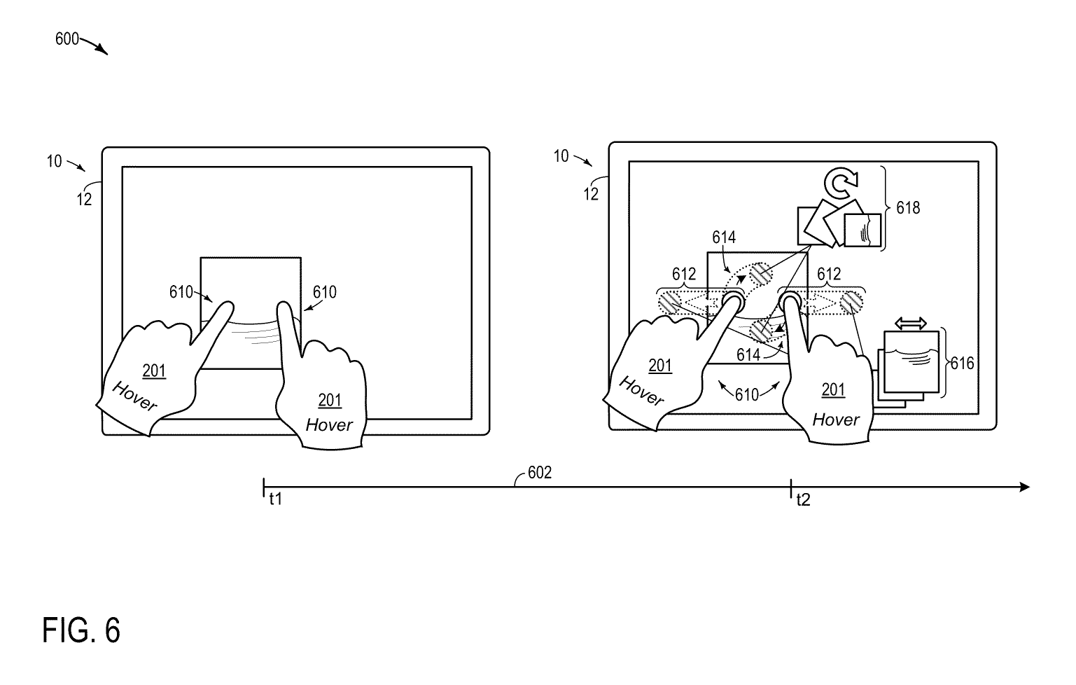

FIG. 6 shows an input sequence in which a user-input hover 610 is staged away from the display 12. Various steps of the user-input sequence are delineated via a timeline 602. At t1, an input sequence is initiated by a user. The initiation is executed through implementation of a user-input hover 610. The user-input hover is detected by an input sensing subsystem and determined to correspond to a recognized posture by a natural input trainer, as described above.

In response to detection of the-user input hover, a predictive input cue is presented on the display at t2. In the depicted embodiment, the predictive input cue includes a graphical representation 612 of a first proposed user-input action gesture (e.g., user-input touch) executable in the functionally-active region and associated with a first computing function and a graphical representation 614 of a second proposed user-input action gesture executable in the functionally-active region and associated with a second computing function. The predictive input cue may further include a first contextual function preview 616 graphically representing a foreshadowed implementation of the first computing function and a second contextual function preview 618 graphically representing a foreshadowed implementation of the second computing function. In this way, a number of proposed user-input action gestures may be presented to the user at one time, allowing the user to quickly expand their gestural repertoire. Different predictive input cues may be presented with visually distinguishable features (e.g., coloring, shading, etc.) so that a user may intuitively deduce which cues are associated with which gestures.

FIG. 7 illustrates another embodiment of a computing device 700 including an input-sensing subsystem configured to detect precursory user-input preactions executed in an instructive region 714 and user-input action gestures executed in a functionally-active region 712. As shown, the functionally-active region 712 and the instruction region 714 may be 3-dimensional regions spaced away from a display 710. Therefore, the instructive region may constitute a first 3-dimensional volume and the functionally-active region may constitute a second 3-dimensional volume, in some embodiments. In such embodiments, the input sensing subsystem may include a capture device 722 configured to detect 3-dimensional gestural input. In some examples, the functionally-active region and the instructive region may be positioned relative to a user's body 716. However, in other examples the functionally-active region and the instructive region may be position at a predetermined distance from the display.

A predictive input cue may be presented on the display 710 in response to the input sensing subsystem detecting a precursory posture performed in the instructive region 714. As previously discussed, the predictive input cue may include a graphical representation 718 of a proposed user-input action gesture executable in the functionally-active region and associated with a computing function if the precursory posture corresponds to a recognized posture. The predictive input cue may further include a contextual function preview 720 graphically representing a foreshadowed implementation of the computing function.

The capture device 722 may be used to recognize and analyze movement of the user in the instructive region as well as the functionally-active region. The capture device may be configured to capture video with depth information via any suitable technique (e.g., time-of-flight, structured light, stereo image, etc.). As such, the capture device may include a depth camera, a video camera, stereo cameras, and/or other suitable capture devices.

For example, in time-of-flight analysis, the capture device 722 may emit infrared light to the target and may then use sensors to detect the backscattered light from the surface of the target. In some cases, pulsed infrared light may be used, wherein the time between an outgoing light pulse and a corresponding incoming light pulse may be measured and used to determine a physical distance from the capture device to a particular location on the target. In some cases, the phase of the outgoing light wave may be compared to the phase of the incoming light wave to determine a phase shift, and the phase shift may be used to determine a physical distance from the capture device to a particular location on the target.

In another example, time-of-flight analysis may be used to indirectly determine a physical distance from the capture device to a particular location on the target by analyzing the intensity of the reflected beam of light over time via a technique such as shuttered light pulse imaging.

In another example, structured light analysis may be utilized by capture device to capture depth information. In such an analysis, patterned light (i.e., light displayed as a known pattern such as a grid pattern or a stripe pattern) may be projected onto the target. On the surface of the target, the pattern may become deformed, and this deformation of the pattern may be studied to determine a physical distance from the capture device to a particular location on the target.

In another example, the capture device may include two or more physically separated cameras that view a target from different angles, to obtain visual stereo data. In such cases, the visual stereo data may be resolved to generate a depth image.

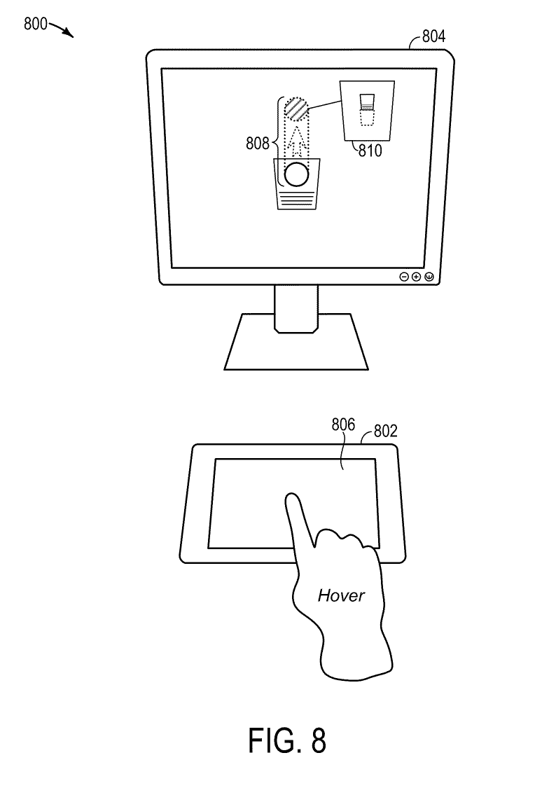

FIG. 8 illustrates another embodiment of a computing device 800 including an input-sensing subsystem configured to detect precursory user-input preactions executed in an instructive region and user-input action gestures executed in a functionally-active region.

In the depicted embodiment the input-sensing subsystem includes an input device 802 spaced away from a display 804. As such, input device 802 is capable of detecting user input hovers staged away from display 804. As shown the input device and the display are enclosed by separate housings. However, in other embodiments the input device and the display may reside in a single housing. It will be appreciated that the input device may include an optical sensing subsystem, a capacitive sensing subsystem, a resistive sensing subsystem, and/or a any other suitable sensing subsystem. Furthermore, the functionally-active region is a sensing surface 806 on the input device and the instructive region is located directly above the sensing surface. Therefore a user may implement various inputs, such as a user-input touch and a user-input hover, through the input device 802.

A predictive input cue may be presented on the display 804 in response to the input sensing subsystem detecting a precursory posture performed in the instructive region. As previously discussed, the predictive input cue may include a graphical representation 808 of a proposed user-input action gesture executable in the functionally-active region and associated with a computing function if the precursory posture corresponds to a recognized posture. The predictive input cue may further include a contextual function preview 810 graphically representing a foreshadowed implementation of the computing function.

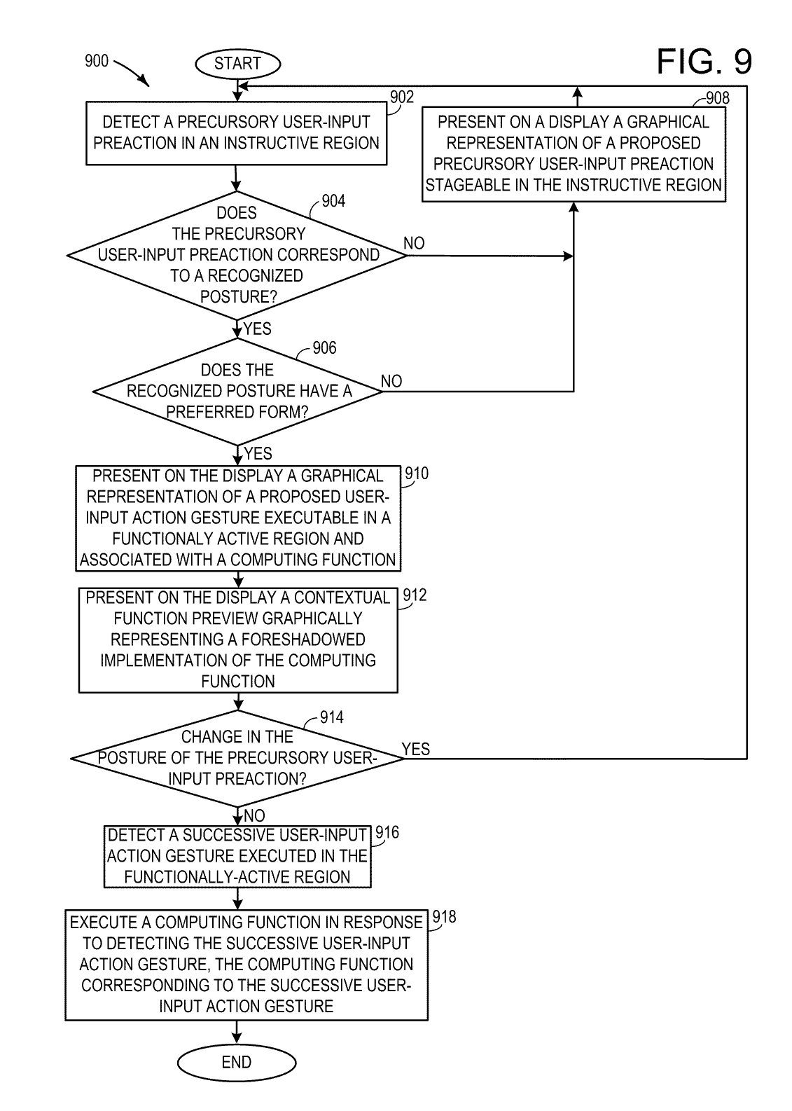

FIG. 9 illustrates an example method 900 for teaching user-input techniques to a user of a computing device and implementing computing functions responsive to user-input. The method 900 may be implemented using the hardware and software components of the systems and devices described herein, and/or via any other suitable hardware and software components.

At 902, method 900 includes detecting a precursory user-input preaction staged away from a display in an instructive region. The instructive region may be adjacent to a sensing surface of the display or in a three-dimensional space away from the display. At 904, method 900 includes determining if the precursory user-input preaction corresponds to a recognized posture. Various techniques may be used to determine if the precursory user-input preaction corresponds to a recognized posture, as previously discussed.

If the precursory user-input preaction corresponds to a recognized posture (i.e., YES at 904), the method proceeds to 906 where it is determined if the recognized posture has a preferred form. The form of the posture may be determined by various characteristics of the posture, such as hand(s) used to implement the posture, the digits used for input, the location of the input, etc. It will be appreciated that in some examples, the preferred form may be a bio-mechanically effective form.

If the precursory user-input preaction does not correspond to a recognized posture (i.e., NO at 904), or if it the recognized posture does not have a preferred form (i.e., NO at 906), at 908, method 900 includes presenting on a display a graphical representation of a proposed precursory user-input preaction stageable in the instructive region, as described above.

However, if the recognized posture has a preferred form (i.e., YES at 906), at 910, method 900 includes presenting on the display a graphical representation of a proposed user-input action gesture executable in a functionally-active region and associated with a computing function. In this way, the user may be provided with a tutorial, allowing a user to easily learn the input gesture. It will be appreciated that in some embodiments a plurality of graphical representations of proposed user-input action gestures may be presented on the display.

At 912, the method includes presenting on the display a contextual function preview graphically representing a foreshadowed implementation of the computing function on the display. This allows a user to view the implementation of the computing function associated with the proposed user-input action gesture before a user-input action gesture is carried out. Therefore, a user may alter subsequent gestural input based on the contextual function preview, in some situations.

At 914, the method includes determining if a change in the posture of the precursory user-input preaction has occurred. In this way, a user may alter the posture of the precursory user-input preaction based on the predictive input cue. In other words, a user may view the predictive input cue, determine that the suggested input is not intended, and alter the precursory user-input preaction accordingly.

If it is determined that a change in the posture of the precursory user-input preaction has occurred (i.e., YES at 914) the method returns to 902. However, if it is determined that a change in the posture of the precursory user-input preaction has not occurred (i.e., NO at 914) the method includes, at 916, detecting a successive user-input action gesture executed in the functionally-active region.

At 918, the method includes executing a computing function in response to detecting the successive user-input action gesture, the computing function corresponding to the successive user-input action gesture. After 918 the method 900 ends.

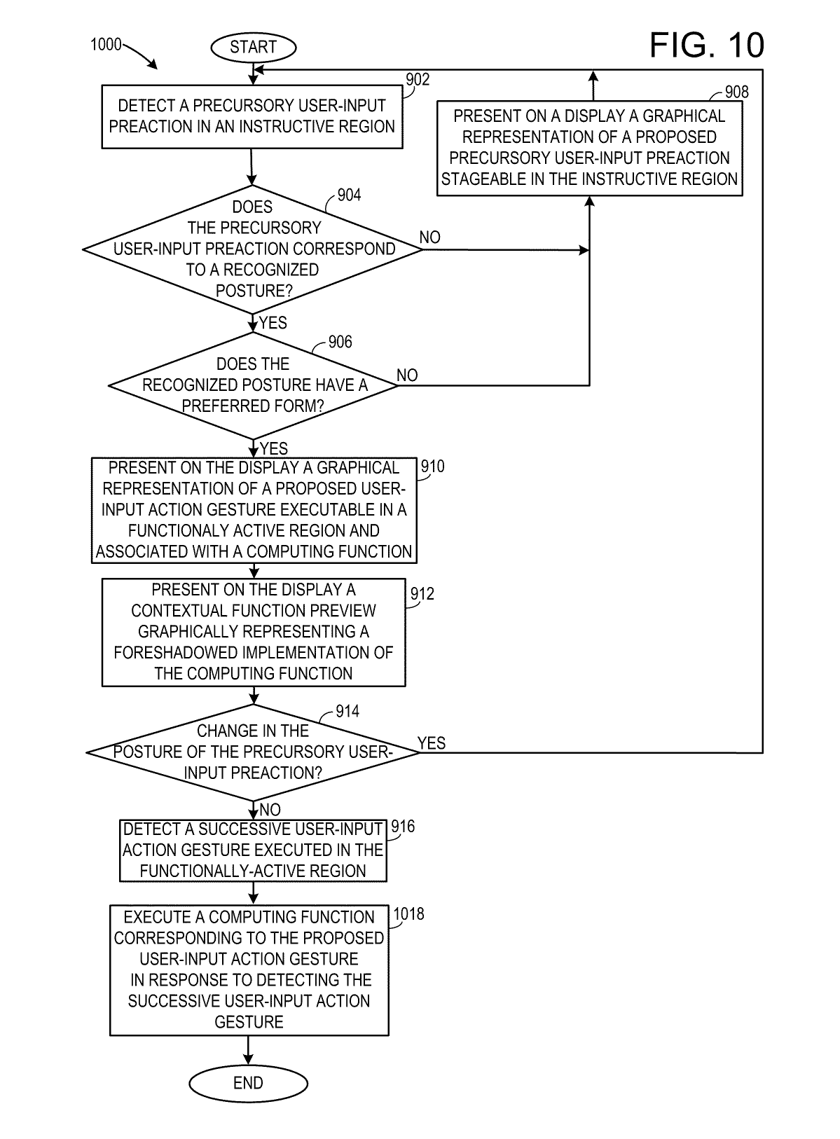

FIG. 10 illustrates an example method 1000. FIG. 10 follows the same process flow as depicted in method 900 until 916. At 1018 the method includes executing a computing function corresponding to the proposed user-input action gesture in response to detecting the successive user-input action gesture. In this way, the computing function corresponding to the proposed user-input action gesture is implemented regardless of the characteristics of the successive user-input action gesture. Method 1000 may decrease the time needed to process the successive user-input action gesture and conserve computing resources.

The systems and methods for gestural recognition described above allows novice or infrequent users to quickly learn various user-input action gestures through graphical input cues, thereby easing the learning curve corresponding to gestural input and decreasing user frustration.

As described with reference to FIG. 1, the above described methods and processes may be tied to a computing system 10. Computing system 10 includes a logic subsystem 24 and a data-holding subsystem 26.

Logic subsystem 24 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments. Furthermore the logic subsystem 24 may be in operative communication with the display 12 and the input sensing subsystem 14.

Data-holding subsystem 26 may include one or more physical devices configured to hold data and/or instructions executable by the logic subsystem to implement the herein described methods and processes. When such methods and processes are implemented, the state of Data-holding subsystem 26 may be transformed (e.g., to hold different data). Data-holding subsystem 26 may include removable media and/or built-in devices. Data-holding subsystem 26 may include optical memory devices, semiconductor memory devices, and/or magnetic memory devices, among others. Data-holding subsystem 26 may include devices with one or more of the following characteristics: volatile, nonvolatile, dynamic, static, read/write, read-only, random access, sequential access, location addressable, file addressable, and content addressable. In some embodiments, Logic subsystem 24 and Data-holding subsystem 26 may be integrated into one or more common devices, such as an application specific integrated circuit or a system on a chip.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a display to visually present images to a user;
an input sensing subsystem to detect user-input hovers staged away from the display; and
a natural input trainer to present a predictive input cue on the display in response to the input sensing subsystem detecting a user-input hover staged away from the display.

2. The computing device of claim 1, wherein the predictive input cue includes a graphical representation of a proposed user-input touch executable against a touch-sensor and associated with a computing function if the user-input hover corresponds to a recognized posture.

3. The computing device of claim 1, wherein the predictive input cue includes a graphical representation of a proposed user-input hover stageable away from the display and associated with a set of input gestures if the user-input hover does not correspond to a recognized posture.

4. The computing device of claim 1, wherein the natural input trainer presents the predictive input cue after the user-input hover remains substantially stationary for a predetermined time period.

5. The computing device of claim 4, wherein the natural input trainer is configured to present a second predictive input cue in response to the user-input hover remaining substantially stationary for a second predetermined time period.

6. The computing device of claim 1, where the input sensing subsystem is configured to detect user-input touches executed against the display, and the computing device further comprises an interface engine to execute a computing function in response to the input sensing subsystem detecting a successive user-input touch executed against the display subsequent to the user-input hover staged away from the display.

7. The computing device of claim 6, wherein the computing function corresponds to the predictive input cue presented in response to the user-input hover.

8. The computing device of claim 6, wherein the computing function corresponds to one or more characteristics of the successive user-input touch executed against the display.

9. The computing device of claim 6, further comprising:
a logic subsystem in operative communication with the display and the input sensing subsystem; and
a data-holding subsystem holding instructions executable by the logic subsystem to present the predictive input cue and to execute the computing function.

10. The computing device of claim 6, wherein the predictive input cue includes a contextual function preview graphically representing a foreshadowed implementation of the computing function.

11. A computing device, comprising:
a display to visually present images to a user;
an input sensing subsystem to detect precursory user-input preactions executed in an instructive region and user-input action gestures executed in a functionally-active region; and
a natural input trainer to present a predictive input cue on the display in response to the input sensing subsystem detecting a precursory user-input preaction performed in the instructive region;
an interface engine to execute a computing function in response to the input sensing subsystem detecting a successive user-input action gesture performed in the functionally-active region subsequent to detection of the precursory user-input preaction.

12. The computing device of claim 11, wherein the functionally-active region is spaced away from the display.

13. The computing device of claim 11, wherein the predictive input cue includes a graphical representation of a proposed user-input action gesture executable in the functionally-active region and associated with a computing function if the precursory user-input preaction corresponds to a recognized posture.

14. The computing device of claim 11, wherein the predictive input cue includes a graphical representation of a proposed precursory user-input preaction stageable in the instructive region and associated with a set of input gestures if the precursory user-input preaction does not correspond to a recognized posture.

15. The computing device of claim 11, further comprising:
a logic subsystem in operative communication with the display and the input sensing subsystem; and
a data-holding subsystem holding instructions executable by the logic subsystem to present the predictive input cue and to execute the computing function.

16. The computing device of claim 11, wherein the input sensing subsystem includes a depth camera to detect 3-dimensional gestural input.

17. The computing device of claim 11, wherein the input sensing subsystem includes an infrared, vision-based, touch detection camera.

18. A method for teaching user-input techniques to a user of a computing device and implementing computing functions responsive to user-input comprising:
detecting a first precursory user-input preaction staged in an instructive region;
if the first precursory user-input preaction corresponds to a recognized posture, presenting on a display a graphical representation of a first proposed user-input action gesture that is executable in a functionally-active region and associated with a first computing function;
detecting a second precursory user-input preaction staged in the instructive region, the second precursory user-input preaction different than the first precursory user-input preaction;
if the second precursory user-input preaction corresponds to a recognized posture, presenting a graphical representation of a second proposed user-input action gesture that is executable in the functionally-active region and associated with a second computing function;
detecting a successive user-input action gesture executed in the functionally-active region subsequent to the first precursory user-input preaction and the second precursory user-input preaction; and
executing the second computing function in response to detecting the successive user-input action gesture.

19. The method of claim 18, wherein detecting the first precursory user-input preaction includes using an infrared, vision-based, touch detection camera to detect a user-input hover above a display surface; and wherein detecting the successive user-input action gesture includes using the infrared, vision-based, touch detection camera to detect a touch against the display surface.

20. The method of claim 18, wherein detecting the first precursory user-input preaction includes using a depth camera to detect a 3-dimensional gestural input in a 3-dimensional volume constituting the instructive region; and wherein detecting the successive user-input action includes using the depth camera to detect a 3-dimensional gestural input in a 3-dimensional volume constituting the functionally-active region.
